(19) United States
(12) Patent Application Publication
(10) Pub. No.: US 2004/0237561 A1
(43) Pub. Date: Dec. 2, 2004

(54) System for utilizing water originating from the air conditioning system in order to supply water to the automobile windshield wiper reservoir

(76) Inventor: Walter Duarte Barreto Junior, Lauro de Freitas (BR)

Correspondence Address: RICHARD M. GOLDBERG, 25 EAST SALEM SREEET, SUITE 419, HACKENSACK, NJ, 07601, US

(21) Appl. No.: 10/780,044

(22) Filed: Feb. 17, 2004

(30) Foreign Application Priority Data
May 26, 2003 (BR) MU8301358-0

(51) Int. Cl. F25D 21/14; F25D 23/00; A62C 13/66; A62C 13/62; B05B 9/03; A62C 35/58

(52) U.S. Cl. 62/285; 62/291; 239/302

(57) ABSTRACT

A system for utilizing water originating from an air conditioning system in order to supply water to an automobile windshield wiper system, includes air conditioning generating equipment for an automobile, the air conditioning generating equipment including a compressor, a condenser and an evaporating compartment; a water-collecting container positioned below a level of the evaporating compartment; first tubing for connecting the evaporating compartment to the water-collecting container to supply water from the evaporating compartment to the water-collecting container; second tubing for connecting the water-collecting container to a windshield wiper system of the automobile; and a pump for pumping the water from the water-collecting container to the windshield wiper system through the second arrangement.

### BACKGROUND OF THE INVENTION

The present invention relates to a system that utilizes water from humidity condensation originating from the automobile's air conditioning equipment and supplies water to a reservoir that cleans the automobile's windshield.

It is well known that all air conditioning equipment produces a constant dripping of water while it is functioning. This also happens in an automobile's air conditioning equipment, and this water is reused and once again put to such good use that it has become a reason for an important commercial demand in the automotive sector. There are many people who do not know how, do not enjoy or are unaware of how to perform car maintenance. For some people, refueling the automobile once every week is enough of an unpleasant task. Even more unpleasant yet is stopping at a gas station to refuel and still having to open the car hood in order to perform some service.

New cars already have two great advantages in regard to older models: the motor oil level does not decrease, making it necessary to change oil only on scheduled car-checkup dates; and there is no need to complete cooling water for the motor since it is always at the appropriate level. However, there still exists a need to open the car hood and fill up the water reservoir for the windshield wipers.

For the car owner it would be much more accommodating if it were never necessary to open the car hood when stopping at a gas station, leaving this work for automobile concessionaires on the scheduled date for a vehicle checkup.

Therefore, the windshield wiper reservoir should have an automatic water supply system, eliminating the sole reason for which it is necessary to open the automobile's hood at these fuel stops.

### SUMMARY OF THE INVENTION

The system that is the object of this application includes installation of a water-collecting container placed immediately below the air conditioner's evaporation compartment in order to collect the water originating from humidity condensation of the air in this location that by gravity passes to the water-collecting container through a tube or passage. This water-collecting container shall have a size and shape that is convenient for the space available in the automobile's motor, near the upper portion, also an exit from which excess water is eliminated that may accumulate in the collecting container, thus preventing water from returning to the evaporating compartment.

### BRIEF DESCRIPTION OF THE DRAWINGS

FIG. 1 is a view that exclusively shows the equipment that is part of this system, and

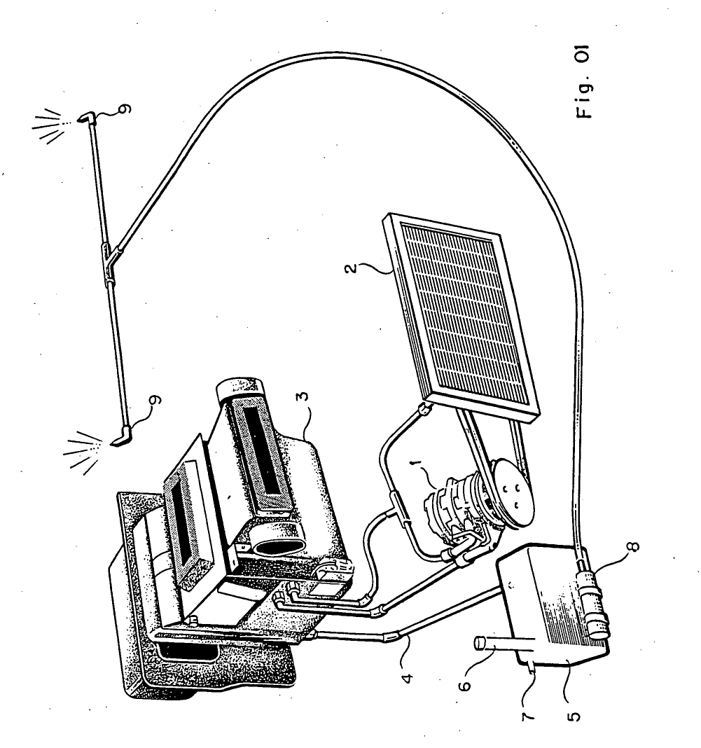

FIG. 2 shows this equipment installed in the automobile with the difference that in this Figure the water-collecting container is located immediately below the evaporating compartment.

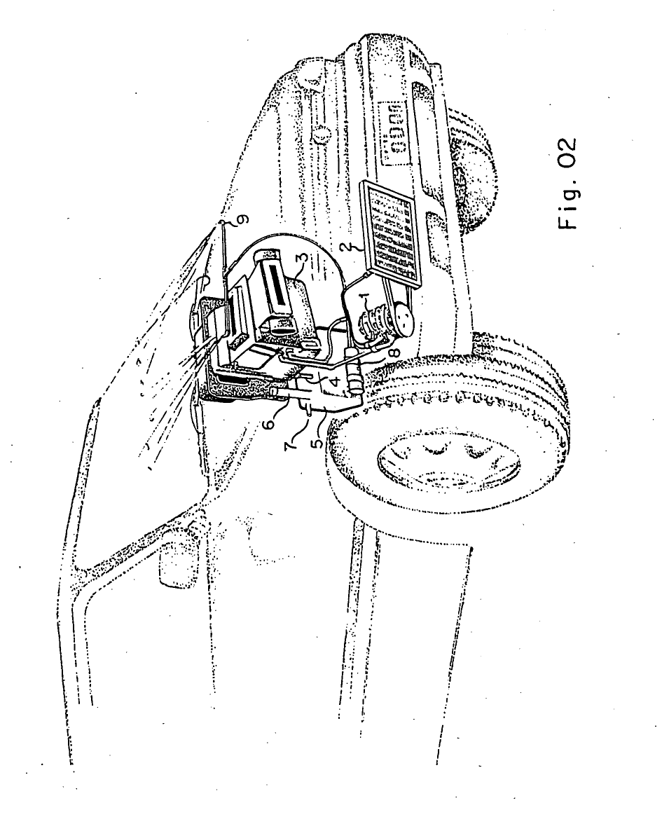

### DETAILED DESCRIPTION

As may be inferred from the drawings, the system is comprised of the equipment necessary for generating air conditioning, including a compressor 1, an evaporating compartment 2 and a water-collecting container 3. A water-collecting container 5 receives water from the evaporating compartment 3 through a duct 4. Water-collecting container 5 is positioned below the level of the evaporating compartment 3. The water-collecting container 5 has an entrance 6 that is long enough to reach the upper portion of the motor in order that, if necessary, the same may be supplemented manually with water. It also has an exit 7 that eliminates excess water, thus preventing such water from returning to the evaporation compartment 3. Finally, there is a motor 8 for propelling the water from the collecting container 5 to the windshield wiper jets 9.

What is claimed is:

1. A system for utilizing water originating from an air conditioning system in order to supply water to an automobile windshield wiper system, comprising:
air conditioning generating equipment for an automobile, the air conditioning generating equipment including an evaporating compartment;
a water-collecting container positioned below a level of the evaporating compartment;
a first arrangement for connecting the evaporating compartment to the water-collecting container to supply water from the evaporating compartment to the water-collecting container;
a second arrangement for connecting the water-collecting container to a windshield wiper system of the automobile; and
a pump for pumping the water from the water-collecting container to the windshield wiper system through the second arrangement.

2. A system according to claim 1, wherein said air conditioning generating equipment further comprises a compressor and a condenser.

3. A system according to claim 1, wherein said first arrangement includes tubing which connects the evaporating compartment to the water-collecting container.

4. A system according to claim 1, wherein the second arrangement includes tubing which connects the water-collecting container to a windshield wiper system.
